(19) United States
(12) Patent Application Publication
(10) Pub. No.: US 2026/0256327 A1
(43) Pub. Date: Sep. 3, 2026

(54) SANITARY CUBICLE

(71) Applicant: TOI TOI & DIXI GROUP GMBH, Ratingen (DE)

(72) Inventors: Holger Martin WIRTZ, Neuss (DE); Stephan DIWISCH, Bad Hersfeld (DE); Tim WORIESCHECK, Bad Zwischenahn (DE)

(21) Appl. No.: 18/713,183

(22) PCT Filed: Nov. 25, 2022
(86) PCT No.: PCT/EP2022/083321

§ 371 Date: Jun. 18, 2024

(30) Foreign Application Priority Data
Dec. 17, 2021 (DE) 10 2021 133 721.6

(51) Int. Cl. A47K 11/02; A01N 25/10; A01N 59/26; A01P 1/00; B29C 41/00; B29C 41/04; B29K 105/00; B29L 31/00; C09D 5/14; C09D 123/06

(52) U.S. Cl. CPC A47K 11/02; A01N 25/10; A01N 59/26; A01P 1/00; B29C 41/003; C09D 5/14; C09D 123/06; B29C 41/04; B29K 2023/06; B29K 2105/0011; B29L 2031/7694

(57) ABSTRACT

The invention relates to a sanitary cubicle comprising at least one floor part, at least one roof part and a plurality of sidewall parts. At least one sanitary device and at least one tank for wastewater and/or faeces are also provided. At least one structural component of the sanitary cubicle is provided with antimicrobial properties. For this purpose, at least one surface region of the structural component, preferably the entire structural component or substantially the entire structural component, is made of a material containing at least one antimicrobial additive.

The invention relates to a sanitary cubicle, in particular a toilet cubicle, comprising at least one floor, at least one roof and a plurality of side walls, wherein furthermore at least one sanitary device and at least one tank for waste water and/or feces are provided. Furthermore the invention relates to a method of making such a sanitary cubicle. It is recommended that the sanitary cubicle according to the invention is a mobile or transportable sanitary cubicle. Such mobile sanitary cubicles can be transported in particular on transport vehicles. They can be used particularly flexibly in places where there are no permanently installed sanitary facilities. The mobile sanitary cubicles are therefore usually set up for specific periods of time, for example on construction sites or at events such as markets, trade fairs, festivals and the like. The mobile or transportable sanitary cubicles are then removed again and cleaned.

Sanitary cubicles of the type described above are basically known from practice in different embodiments. The sanitary cubicles known from practice have at least one sanitary device, for example a toilet bowl. It is furthermore fundamentally known to provide additional devices for the hygiene of the user in the sanitary cubicles. These include other sanitary devices such as hand-wash basins or hygiene devices such as soap dispensers. Such sanitary cubicles have fundamentally proven successful in terms of their compactness and flexible use and also in terms of the measures and devices conducive to the hygiene of the user. However, it has been shown in the sanitary cubicles known from practice that microbes, for example, bacteria can accumulate with time on the surfaces of the structural components of the sanitary cubicle. Even though many of the well-known sanitary cubicles have devices that are conducive to the hygiene of the user, the accumulation of microbes on the surfaces of the structural components of the sanitary cubicles is nevertheless undesirable. This also applies in particular to sanitary cubicles that do not have additional devices such as hand-wash basins, soap dispensers and the like. It is additionally known from practice that the sanitary cubicles installed at the site are cleaned at certain intervals, wherein the structural components of the sanitary cubicle and their surfaces are usually disinfected. This is time consuming and costly. In addition, it is also desirable to ensure that the sanitary cubicles are at least largely free of microbes in the period between cleaning processes. This is where the invention comes in.

In view of this, the invention is based on the technical problem of providing a sanitary cubicle, in particular a toilet cubicle, of the type mentioned initially, in which the disadvantages described above can be effectively and reliably avoided and in which, in particular, the accumulation of microbes on structural components of the sanitary cubicle can at least be reduced and can preferably be largely avoided. Furthermore, the invention is based on the technical problem of providing a method of making such a sanitary cubicle.

In order to solve the technical problem, the invention teaches a sanitary cubicle, in particular a toilet cubicle, comprising at least one floor, at least one roof and a plurality of side walls, wherein furthermore at least one sanitary device and at least one tank for waste water and/or feces are provided, wherein at least one structural component of the sanitary cubicle is provided with antimicrobial properties and wherein for this purpose at least one surface region of the structural component, preferably the entire structural component or substantially the entire structural component, is made of a material containing at least one antimicrobial additive.

The expression “structural component of the sanitary cubicle” in the context of the invention refers in particular to a part or component of the sanitary cubicle consisting of a plurality of parts or components. Structural components of the sanitary cubicle are, for example, the floor, the roof, the individual side walls, at least one sanitary device or individual parts of this sanitary device or the tank for waste water and/or feces. Other structural components of the sanitary cubicle can be, for example, support posts or corner posts, hygiene functional devices, a cubicle door, a door handle or a locking device. These structural components are explained in more detail below. In the context of the invention, the surface region of a structural component means in particular a region extending from a structural component surface to a certain depth into the structural component. The user of the sanitary cubicle may come into contact with the surfaces of the structural components when entering and leaving the sanitary cubicle and when using the sanitary cubicle. It is within the scope of the invention that the surface region of the structural component provided with antimicrobial properties and made from a material containing at least one antimicrobial additive, has a thickness of at least 0.5 mm, preferably of at least 0.8 mm, preferably of at least 1 mm and particularly preferably of at least 2 mm. Particularly preferably the entire structural component or substantially the entire structural component provided with antimicrobial properties is made of a material containing at least one antimicrobial additive.

It has already been pointed out above that the sanitary cubicle according to the invention, according to a preferred embodiment, is a mobile or transportable sanitary cubicle, in particular a mobile or transportable toilet cubicle. Thus, the sanitary cubicle according to the invention is expediently configured to be relatively compact and in this context it is within the scope of the invention that the volume of the interior of the sanitary cubicle is only 1 to 4 m³, preferably 1.25 to 3.5 m³ and particularly preferably 1.25 to 3 m³.

In the context of the invention, the expression antimicrobial additive means in particular an additive that is capable of destroying microbes, for example bacteria, present on the surface of the structural component and/or reducing their ability to reproduce. It is particularly preferred within the scope of the invention that the antimicrobial additive is an additive containing or releasing antimicrobially acting metal ions.

Preferably, the antimicrobial additive is an additive containing or releasing silver ions and/or zinc ions and/or copper ions. It is possible that the antimicrobial additive is a silver salt and/or a zinc salt and/or a copper salt. Preferably, the antimicrobial additive is a silver phosphate and particularly preferably a silver phosphate glass. It is within the scope of the invention that the additive containing or releasing antimicrobially acting metal ions releases the metal ions and that these metal ions migrate to the surface of the structural component and are antimicrobially active there. According to one embodiment of the invention, the additive containing or releasing antimicrobially acting metal ions is a zeolite.

A particularly preferred embodiment of the sanitary cubicle according to the invention is characterized in that a plurality of support posts or corner posts are provided, wherein the side walls of the sanitary cubicle connect the support posts or corner posts to one another and wherein preferably the at least one structural component of the sanitary cubicle provided with antimicrobial properties is at least one support post or corner post. It is preferred that the sanitary cubicle has four support posts or four corner posts. It is recommended that the sanitary cubicle has a roof and four support posts configured as corner posts, wherein the corner posts connect the roof to the floor. According to a preferred embodiment of the invention, the at least one structural component of the sanitary cubicle provided with antimicrobial properties is at least one support post or corner post and, particularly preferably, all the support posts or all four corner posts of the sanitary cubicle are provided with antimicrobial properties. In this context, it is further preferred that at least a part of the support posts or corner posts, preferably all the support posts or corner posts of the sanitary cubicle are formed as one piece with respect to their longitudinal extension and are particularly preferably formed as one-piece plastic parts.

It has already been mentioned above that four support posts configured as corner posts are preferably provided to connect the roof with the floor of the sanitary cubicle. It is recommended that a tongue-and-groove connection is provided between a support post or the corner post and the roof and/or the floor. It has proven successful if the support posts and/or corner posts each have a tongue element at their ends that interacts with a complementary groove element on the roof or on the floor by engaging in this groove element. According to a particularly preferred embodiment, the tongue-and-groove connecting elements provided on the support posts or corner posts and on the roof or the floor each have holes that are aligned with each other. In this way, the respective support post or corner post are connected to the roof or to the floor by at least one connecting element that passes through the aligned holes. Expediently, such a connecting element is a connecting bolt or a connecting screw.

A recommended embodiment of the invention is characterized in that four support posts or corner posts of the cubicle each have at least one tongue element or one tongue element at their two ends and that the roof and/or the floor each have four groove elements for an interaction with the associated four tongue elements of the posts. Expediently the said holes and the said connecting element passing through the holes in each case are provided on each tongue-and-groove connection between the posts and the roof or the floor. According to a particularly preferred embodiment of the sanitary cubicle according to the invention, a connecting screw as a connecting element passes through the hole penetrating the tongue element and the groove element and preferably at least one nut is then pulled from the inside of the cubicle onto the thread of the connecting screw for the purpose of fixing the tongue-and-groove connection.

As has proven successful, a side wall of the sanitary cubicle connects two support posts or corner posts together. To create this connection, tongue-and-groove connections are preferably set up between the side wall and the two support posts or corner posts. For this purpose, the side wall expediently has at least one tongue element at its outer edges facing the support post or corner post that engages in a complementary groove of the support post or corner post. The at least one tongue element then extends at least over a large part of the vertical length of the side wall. The complementary groove assigned to the tongue element in the support post or corner post accordingly preferably also extends over at least a large part of the vertical length of the post. The term vertical refers in particular to the vertical installation state of the sanitary cubicle according to the invention, in which the floor is on a mounting surface. Expediently in a preferred sanitary cubicle with four support posts or corner posts, three of these posts have two posts each connected to each other via a side wall.

It is also within the scope of the invention that the sanitary cubicle according to the invention is rectangular or square in plan view and preferably with rounded corners. In this preferred embodiment of the sanitary cubicle according to the invention with rounded corners, the corner posts at these corners are expediently configured to be rounded on their outer side.

It is particularly preferred that at least some of the structural components of the sanitary cubicle, in particular at least the floor and/or the roof and/or the side walls and/or the support posts or corner posts consist of or substantially consist of plastic, preferably of thermoplastic material. The thermoplastic material is preferably polyethylene. It is further preferred that the at least one sanitary device and/or the at least one tank consists/consist of or substantially consists/consist of plastic, preferably of thermoplastic material. The thermoplastic material is preferably polyethylene. The fact that a structural component of the sanitary cubicle consists or substantially consists of plastic means within the context of the invention, in particular that additives or admixtures may be added to the plastic. The structural component then preferably consists of at least 95% by weight, preferably at least 98% by weight, of the at least one plastic or thermoplastic material. It is within the scope of the invention that the floor and/or the roof and/or the side walls and/or the tank and/or the support posts or corner posts are configured as one-piece plastic parts.

According to a particularly recommended embodiment of the invention, the material containing the at least one antimicrobial additive of the at least one structural component provided with antimicrobial properties is a plastic containing the at least one antimicrobial additive, preferably a thermoplastic material, preferably a polyolefin, particularly preferably polyethylene. If, according to the invention, at least one surface region of the at least one structural component provided with antimicrobial properties is made from the material containing at least one antimicrobial additive, then at least this surface region is preferably made from a thermoplastic material containing at least one antimicrobial additive, preferably from a polyolefin, particularly preferably from polyethylene. Quite particularly preferably, the entire or substantially the entire at least one structural component provided with antimicrobial properties is made of a thermoplastic material containing at least one antimicrobial additive, preferably of a polyolefin, particularly preferably of polyethylene. This embodiment has proven particularly successful within the scope of the invention.

An embodiment that is of quite particular importance within the scope of the invention is characterized in that the material of the surface region of the at least one antimicrobially equipped structural component, expediently the material of the entire at least one antimicrobially equipped structural component, contains 0.05 to 2.5% by weight, preferably 0.07 to 2.0% by weight, more preferably 0.1 to 1.5% by weight, particularly preferably 0.12 to 1.0 % by weight, quite particularly preferably 0.15 to 0.6% by weight, for example 0.2 to 0.5% by weight of the at least one antimicrobial additive. If only a surface region of the structural component is made of the material containing at least one antimicrobial additive, then the material of this surface region contains the antimicrobial additive in the specified proportion. If, according to a preferred embodiment of the invention, the entire structural component or substantially the entire structural component is made of the material containing at least one antimicrobial additive, then the material of the entire structural component or substantially the entire structural component contains the at least one antimicrobial additive in the previously specified proportion. Expediently, the material of the surface region of the structural component or of the entire structural component that is provided with antimicrobial properties is a polyolefin, preferably polyethylene that contains the antimicrobial additive in the previously specified proportion. It has proven successful that the at least one structural component provided with antimicrobial properties or the structural components of the sanitary cubicle provided with antimicrobial properties are made of polyethylene that contains 0.1 to 1.5% by weight, preferably 0.12 to 1.0% by weight, particularly preferably 0.15 to 0.6% by weight, quite particularly preferably 0.2 to 0.5% by weight, for example 0.4% by weight or about 0.4% by weight of the at least one antimicrobial additive. Preferably, the at least one structural component of the sanitary cubicle provided with antimicrobial properties consists of at least one polyolefin, preferably of polyethylene that contains the at least one antimicrobial additive in the said proportion or substantially consists of at least one polyolefin or of polyethylene containing the at least one antimicrobial additive in the said proportion.

A further preferred embodiment of the invention is characterized in that the at least one structural component of the sanitary cubicle provided with antimicrobial properties is at least one sanitary device, in particular in the form of a toilet bowl and/or a urinal and/or a hand-wash basin. It is possible that at least one structural component of the sanitary cubicle provided with antimicrobial properties is a toilet seat on or at the toilet bowl. According to a further preferred embodiment, the at least one structural component of the sanitary cubicle provided with antimicrobial properties is a toilet lid that in particular closes the toilet bowl. Expediently, the entire structural component unit consisting of the toilet bowl and/or the toilet seat and/or the toilet lid is provided with antimicrobial properties. It is further preferred that all sanitary devices of the sanitary cubicle, in particular the toilet bowl, or the structural component unit consisting of the toilet bowl and/or toilet seat and/or toilet lid, and/or the urinal and/or the hand-wash basin are provided with antimicrobial properties. This embodiment of the invention, in which the at least one structural component of the sanitary cubicle provided with antimicrobial properties is at least one sanitary device, is based on the finding that such structural components, such as the toilet bowl, the toilet seat and the toilet lid, as well as the urinal, can come into contact with feces, so that providing this structural component with antimicrobial properties is particularly preferred because a significant reduction in microbial accumulations on the surfaces of these structural components is thereby achieved. Particular requirements with regard to hygiene are also imposed on the hand-wash basin provided according to the preferred embodiment so that also providing the hand-wash basin with antimicrobial properties is also very preferred and has proven particularly successful.

It is recommended that a side wall of the sanitary cubicle is formed by a cubicle door, wherein preferably at least one door handle and/or at least one locking element is on the cubicle door and wherein preferably the at least one structural component of the sanitary cubicle provided with antimicrobial properties is the cubicle door and/or the door handle and/or the locking element.

In a preferred embodiment of the sanitary cubicle according to the invention with four support posts or corner posts it is recommended that this comprises a four-sided cubicle, in which the fourth side is configured in such a manner that the cubicle door is between two support posts or corner posts, and is conveniently hinged to one of the two posts and is preferably hinged via a hinge. A stop strip for the cubicle door is preferably on the other of the two posts and it is recommended that the cubicle door can be closed here using at least one locking element. It has also proven to be successful that the cubicle door also consists or substantially consists of plastic, preferably of thermoplastic material, preferably of polyethylene. It is recommended that the at least one door handle is located on the cubicle outer side of the cubicle door. The user can open the cubicle door using the door handle. It is recommended that at least one locking element is on the cubicle inner side of the cubicle door that faces the cubicle interior. The user can lock the cubicle door by the locking element. The locking element can, for example, be a rotary latch. It has proven to be successful that the entire structural component assembly comprising the cubicle door and/or the door handle and/or locking element is provided with antimicrobial properties. This embodiment is based on the finding that the user comes into contact with these structural components when entering and leaving the sanitary cubicle and in order to reduce or avoid microbial accumulations, it is therefore advantageous to provide these structural components with antimicrobial properties.

It is within the scope of the invention that the sanitary cubicle has at least one hygiene functional device, in particular at least one disinfectant dispenser and/or at least one soap dispenser and/or at least one paper-towel dispenser, and that preferably the at least one structural component of the sanitary cubicle provided with antimicrobial properties is the at least one hygiene functional device, in particular the disinfectant dispenser and/or the soap dispenser and/or the paper-towel dispenser. It has proven to be successful that all the hygiene functional devices in the sanitary cubicle, in particular the disinfectant dispenser and/or the soap dispenser and/or the paper-towel dispenser, are provided with antimicrobial properties. This embodiment is based on the finding that the user of the sanitary cubicle comes into contact with parts of the respective hygiene functional device when activating the hygiene functional devices, so that an antimicrobial configuration of these structural components is very advantageous and in particular contributes towards reducing the accumulation of microbes on the structural components or the structural component surfaces of the sanitary cubicle.

According to a further preferred embodiment of the sanitary cubicle according to the invention, the structural component of the sanitary cubicle provided with antimicrobial properties is at least one side wall and/or the tank. Preferably, all side walls of the sanitary cubicle are provided with anti-microbial properties. In the preferred embodiment of the sanitary cubicle with three side walls and a cubicle door, the three side walls and/or the cubicle door are preferably provided with antimicrobial properties.

According to a particularly preferred embodiment of the sanitary cubicle according to the invention, a majority of the structural components of the sanitary cubicle are provided with antimicrobial properties. Expediently, at least two, in particular at least three, preferably at least four, preferably at least five, particularly preferably at least six structural components of the sanitary cubicle are provided with antimicrobial properties. It is recommended that the sanitary devices of the cubicle, preferably the toilet bowl, or the structural component assembly comprising the toilet bowl, toilet seat and toilet lid, and/or the hand-wash basin and/or the urinal and more preferably the tank for waste water and/or feces and more preferably the support posts or corner posts of the cubicle and more preferably the side walls and/or the cubicle door and/or the door handle and/or the locking element and more preferably the hygiene functional devices of the sanitary cubicle, preferably the disinfectant dispenser and/or the soap dispenser and/or the paper-towel dispenser, are provided with antimicrobial properties. It is further preferred that all the structural components of the sanitary cubicle according to the invention, with the exception of the roof and/or the floor, are provided with antimicrobial properties.

It has proven to be successful that at least one structural component of the sanitary cubicle provided with antimicrobial properties, preferably at least a part of the structural components provided with antimicrobial properties, preferably the structural components of the sanitary cubicle provided with antimicrobial properties is/are manufactured using the rotational process or by rotational molding. This can comprise, for example, the support posts or corner posts and/or the side walls and/or the cubicle door and/or the toilet bowl and/or the toilet seat and/or the toilet lid and/or the urinal. In principle, individual structural components of the sanitary cubicle can also be manufactured using other manufacturing processes, for example by injection molding, deep drawing and the like. It is also possible that at least one structural component of the sanitary cubicle that is provided with antimicrobial properties, is manufactured by injection molding or deep drawing. These structural components of the sanitary cubicle that are manufactured by injection molding or deep drawing and that are provided with antimicrobial properties, can be, for example, the door handle and/or the locking element.

In order to solve the technical problem, the invention further teaches a method of making a sanitary cubicle, in particular a previously described sanitary cubicle, wherein the sanitary cubicle is constructed from a plurality of structural components, preferably from at least one floor, at least one roof, preferably from a plurality of side walls, from a plurality of support posts or corner posts, as well as at least one sanitary device and at least one tank for waste water and/or feces, wherein at least one of these structural components, preferably a plurality of these structural components, is formed by a rotational process or by rotational molding and wherein a material or a mixture of at least one thermoplastic material and at least one antimicrobial additive is used for this purpose.

It has proven to be successful that, within the scope of the method according to the invention, a fine-particle, in particular a powdery, mixture of at least one fine-particle or powdered thermoplastic material and at least one fine-particle or powdered antimicrobial additive is produced and is subsequently used in the rotational process or in rotational molding. It is further preferred that the thermoplastic material is at least one polyolefin, preferably polyethylene.

According to a preferred embodiment of the method according to the invention, a proportion of the at least one antimicrobial additive in the mixture or in the material comprising at least one thermoplastic material and the at least one antimicrobial additive is 0.05 to 2.5% by weight, preferably 0.07 to 2.0% by weight, more preferably 0.1 to 1.5% by weight, particularly preferably 0.12 to 1.0% by weight, most preferably 0.15 to 0.6% by weight, for example 0.2 to 0.5% by weight.

The invention is based on the finding that with the sanitary cubicle according to the invention it is possible to provide at least one structural component or a plurality of structural components of the sanitary cubicle with antimicrobial properties, so that the accumulation of microbes, for example bacteria, on the structural components or on the surfaces of these structural components can be effectively and reliably reduced. As a result, it is possible to achieve a surprisingly effective reduction in the accumulation of microbes even in the period between cleaning processes of a sanitary cubicle or a mobile sanitary cubicle. In this way, the hygiene requirements are met surprisingly easily and reliably, especially in the period between cleaning processes of the sanitary cubicle. It should also be emphasized that the inventive provision of the components of the sanitary cubicle with antimicrobial properties is characterized by a very advantageously long service life, for example, in comparison with coatings of structural components with antimicrobial substances. Finally, it should be emphasized that the prevention or reduction of an accumulation of microbes on the surfaces of the structural components of the sanitary cubicle is achieved according to the invention with not very complex means, so that the sanitary cubicle according to the invention or the method of making the sanitary cubicle is overall not very complex and in particular not very costly. By providing at least one structural component of the sanitary cubicle with antimicrobial properties according to the invention, preferably a plurality of structural components of the sanitary cubicle with antimicrobial properties, accumulations of microbes, for example bacteria, on the surfaces of these structural components can thus be largely avoided or at least significantly reduced.

The invention is explained in more detail below with reference to a drawing that merely shows an embodiment. In the figures in schematic view:

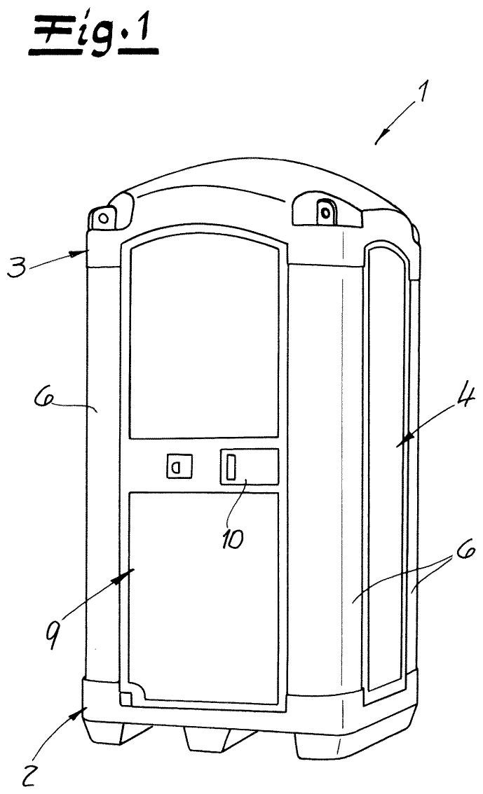

FIG. 1 is a perspective view of a sanitary cubicle or toilet cubicle according to the invention,

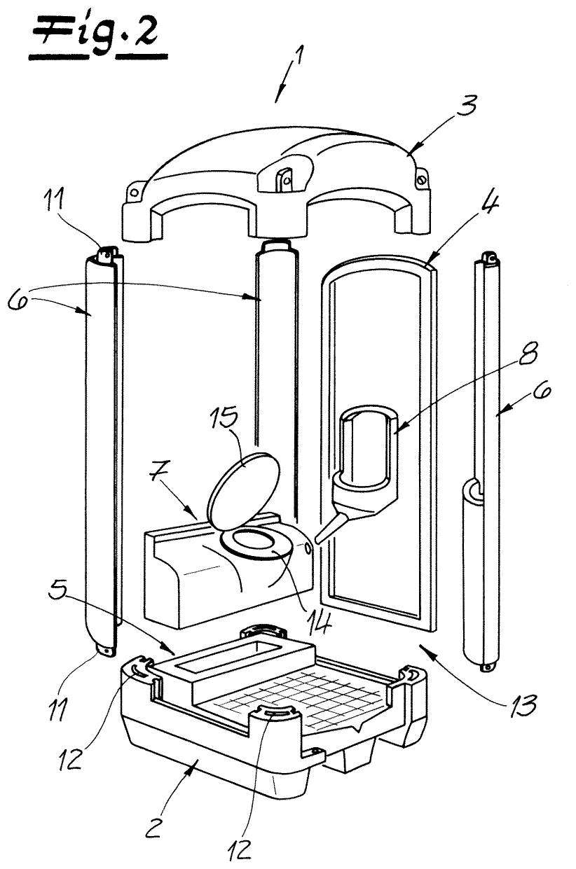

FIG. 2 is an exploded view of the subject matter according to FIG. 1.

The figures show a sanitary cubicle according to the invention that preferably and in this embodiment is configured as a toilet cubicle 1. The sanitary cubicle or toilet cubicle 1 has, as recommended and in this embodiment, a floor 2, a roof 3 and three side walls 4, a cubicle door 9, and four support posts configured as corner posts 6. Preferably and in this embodiment, a door handle 10 is on the cubicle door 9. This door handle 10 allows the user to open the cubicle door 9 or the toilet cubicle 1. In this embodiment, the floor 2 is connected to the roof 1 via the four corner posts 6. Furthermore preferably and in this embodiment, the floor 2 and the roof 3 are connected to one another via the three side walls 4 and via the cubicle door 9.

Expediently and in this embodiment, the corner posts 6 are provided at both ends with a tongue element 11 for a tongue-and-groove connection with the floor 2 or with the roof 3. In this embodiment according to the figures (esp. FIG. 2), both the floor 2 and the roof 3 have a complementary groove element 12 for the engagement of the associated tongue element 11 of the corner post 6. The cubicle door 9 at the front of the sanitary cubicle or toilet cubicle 1 according to the invention is pivotally connected to a corner post 6 via hinges not shown in detail. On the second of the two corner posts 6, between which the cubicle door 9 is arranged, there is expediently a stop strip not shown in detail for the cubicle door 9, on which the cubicle door 9 can be closed via a locking element also not shown in detail. The door handle 10 on the cubicle door 9 is also on the cubicle outer side of the cubicle door 9. The locking element, not shown in detail, is provided on the cubicle inner side of the cubicle door 9.

In the sanitary cubicle or in the interior 13 of the sanitary cubicle, both a toilet bowl 7 and a urinal 8 are preferably and in this embodiment as sanitary devices. Expediently and in this embodiment, a toilet seat 14 and a toilet lid 15 are provided on or at the toilet bowl 7. The sanitary cubicle or toilet cubicle 1 according to the invention further comprises a tank 5 for waste water and/or feces.

Preferably and in this embodiment, a plurality of structural components of the sanitary cubicle or toilet cubicle 1 are provided with antimicrobial properties. For this purpose, it is particularly preferred and in this embodiment that all of the structural components or substantially all of the structural components that are provided with antimicrobial properties are made of a material that contains at least one antimicrobial additive. The at least one antimicrobial additive may be a silver phosphate glass as is proven and in this embodiment.

Preferably and in this embodiment according to the figures, the three side walls 4, the tank 5, the four corner posts 6, the toilet bowl 7, the toilet seat 14, the toilet lid 15, the urinal 8 and the cubicle door 9 are provided with antimicrobial properties and for this purpose the entire structural component or substantially the entire structural component is made of a material containing a silver phosphate glass. In addition, the door handle 10 on the cubicle door 9 and the locking element not shown in detail on the cubicle door 9 are also provided with antimicrobial properties and for this purpose these entire structural components are made of a material containing at least one silver phosphate glass. In this embodiment according to the figures, the material from which the structural components provided with antimicrobial properties are made may be polyethylene containing 0.2 to 0.5% by weight of a silver phosphate glass. As is proven and in this embodiment, the structural components of the sanitary cubicle or toilet cubicle 1 provided with antimicrobial properties consist of polyethylene containing at least one silver phosphate glass or substantially consist of this material. It is also within the scope of the invention that the structural components of the sanitary cubicle that are not provided with antimicrobial properties are made of polyethylene or substantially consist of polyethylene.

It has proven to be successful that at least one of the structural components of the sanitary cubicle provided with antimicrobial properties is manufactured using the rotational process or by rotational molding.

1. A sanitary cubicle comprising:
at floor,
at roof,
a plurality of side walls, the floor, roof, and side walls each being a component of the cubicle;
a sanitary device and a tank for waste water and/or feces and also being a component of the cubicle, and
material including an antimicrobial additive in or forming a surface of at least one of the components of the sanitary cubicle and having antimicrobial properties.

2. The sanitary cubicle according to claim 1, wherein the antimicrobial additive contains or releases antimicrobially acting metal ions.

3. The sanitary cubicle according to claim 1, further comprising:
a plurality of support or corner posts connecting the side walls of the sanitary cubicle to one another and also being components of the cubicle.

4. The sanitary cubicle according to claim 1, wherein at least some of the components of the sanitary cubicle substantially consist of plastic, the sanitary device and/or the tank also substantially consisting of plastic.

5. The sanitary cubicle according to claim 1, wherein the material containing the a antimicrobial additive of the one structural component provided with antimicrobial properties is polyethylene containing the antimicrobial additive.

6. The sanitary cubicle according to claim 1, wherein the material of the surface of the antimicrobially equipped structural component contains 0.05 to 2.5% by weight of the antimicrobial additive.

7. The sanitary cubicle according to claim 1, wherein the component of the sanitary cubicle provided with antimicrobial properties is the sanitary device.

8. The sanitary cubicle according to claim 1, wherein one of the side walls of the sanitary cubicle is formed by a cubicle door and is the component of the sanitary cubicle provided with antimicrobial properties.

9. The sanitary cubicle according to claim 1, wherein the sanitary cubicle a disinfectant dispenser and/or a soap dispenser and/or a paper towel dispenser constituting a component of the sanitary cubicle, and the component of the sanitary cubicle provided with antimicrobial properties is the disinfectant dispenser and/or the soap dispenser and/or the paper-towel dispenser.

10. The sanitary cubicle according to claim 1, wherein the component of the sanitary cubicle provided with antimicrobial properties is one of the side walls and/or the tank.

11. The sanitary cubicle according to claim 1, wherein the component of the sanitary cubicle provided with antimicrobial properties is manufactured using a rotational process or by rotational molding.

12. A method of making a cubicle according to claim 1, wherein
at least one of the components is formed by a rotational process or rotational molding, and
the thermoplastic material and a antimicrobial additive is used for the rotational process or rotational molding.

13. The method according to claim 12, further comprising the step of:
providing a fine-particle or powdery mixture of a fine-particle or powdery thermoplastic material and a fine-particle or powdery antimicrobial additive and subsequently
using the mixture in the rotational process or in rotational molding.

14. The method according to claim 13, wherein the thermoplastic material is polyethylene.

15. The method according to claim 13, further comprising the step of:
providing a proportion of the antimicrobial additive in the mixture or in the material of a thermoplastic material at 0.05 to 2.5% by weight.

16. The sanitary cubicle according to claim 1, wherein the component having the antimicrobial additive is made of polyolefin.

17. The sanitary cubicle according to claim 1, wherein the component having the antimicrobial additive is made of polyethylene.
